(19) United States
(12) Patent Application Publication
(10) Pub. No.: US 2001/0031050 A1
(43) Pub. Date: Oct. 18, 2001

(54) Key generator

(75) Inventors: Bo Domstedt, Malmo (SE); Mats Stenfeldt, Lund (SE)

Correspondence Address: DARBY & DARBY P.C., 805 Third Avenue, New York, NY, 10022, US

(73) Assignee: LATECA COMPUTER INC. N.V.

(21) Appl. No.: 09/780,015

(22) Filed: Feb. 9, 2001

Related U.S. Application Data
(60) Provisional application No. 60/182,356, filed on Feb. 14, 2000.

(51) Int. Cl. H04L 9/00

(52) U.S. Cl. 380/44

(57) ABSTRACT

An apparatus, method and a computer program product for use as a key generator in conversion of message information from a first format into a second format, a first cipher unit (930) is arranged having a first cipher key input (908) and a data output (910) for outputting a data stream generated dependent on a first cipher key (EKEY) input via said first cipher key (908). A second cipher unit (910) having a plaintext input (901), a second cipher key input (903) and a ciphertext output (902) is via said second cipher key input (903) communicatively coupled to said data output (910) of the first cipher unit (930) for receiving a second cipher key (IKEY) in the shape of said data stream; and said first cipher unit (930) being arranged to perform, dependent on a predetermined rule, a renewed generation of a data stream for use as said second cipher key.

The present patent application claims the priority of U.S. Provisional Patent Application No. 60/182,356, filed Feb. 14, 2000, the entirety of which is incorporated herein by reference.

### FIELD OF THE INVENTION

The present invention relates generally to a system for encryption and decryption, respectively, and more specifically to a system arranged for the generation of keys to an existing cipher system.

### BACKGROUND OF THE INVENTION

The encryption and decryption of information has for a long time been an important tool for preventing unauthorized and undesired access to secret information, irrespective of whether this information is stored in a computer, on a computer-readable storage medium, or transmitted between two parties over a communication link. With the evolution of computers and telecommunications technology, the quantity of information created and exchanged on a day to day basis is ever increasing and ever more accessible. The need to prevent undesired access to and possible tampering with this information in a manner that is rapid to implement but ensures high security is therefore greater than ever before.

By encryption, a message or a communication link is protected against unauthorized access or corruption by converting a message to a cryptogram according to a selected conversion function. Usually a function is selected from a family of functions dependent on a so-called cipher key. In the terminology of the trade the expression cipher system refers to a description of a construction of the selected family of cipher functions. For the purpose of the present patent application a cipher system means such a description in the shape of apparatuses and methods that together specify the invention.

It is a difficult task in several aspects to select a good cipher system. Since the consequences of selecting a bad cipher system can be disastrous, for example in the case that important business information falls into the hands of unauthorized people, the cipher systems are usually subject to a number of rules with regard to its construction and use. Within the frame of these rules, there are also such aspects as interoperability between different system parts and other more technical problems. Sometimes these rules are designed in the shape of a national or an international standard. It may for example concern mobile communications networks or the networks for the electronic transactions of the banks.

The rapid development within the computer technology during the last few years has given the crypto analyst the possibility of an extremely fast statistical processing of encrypted messages, causing cipher systems that earlier have been considered safe to be cracked. This fact has considerably increased the demands on the resistance against breaking of the cipher systems. Similarly, the development of programmable electronics has increased the possibilities of crypto analysts to gain unauthorized access of encrypted information. The logical conclusion would be to replace such cipher systems that are out of date, in a sense that they are comparably easy to break, for safer cipher systems. However, for many applications this is in practice not feasible, since large systems and many involved operators restrain the change of cipher systems for financial and other reasons. For example, the possibilities for a single operator in a communications network to replace the cipher system is directly constrained by the fact that all operators have to use the same cipher system according to the presently valid standard. There may also be other more formal obstacles, for example legislation or policy rules controlling what cipher systems are to be used. With regard to the financial aspect the costs of changing an existing cipher system for another and better system may be unacceptably high. In particular, costs arise due to the exchange of a large number of physical cipher units, which perhaps in addition would have to be specifically tested and approved.

Encryption and decryption schemes typically rely on the use of an algorithm in combination with a data sequence or so-called cipher key. Conventionally, symmetric algorithms, wherein the sender and receiver (or creator and reader) of information share the same secret key, are most widespread. These schemes generally fall into one of two classes, stream ciphers and block ciphers. An example of the latter scheme is the Data Encryption Standard (DES) described in U.S. Pat. No. 3,962,539. In such a scheme, the algorithm is time-invariant. In other words two different messages (plaintext) encrypted with the same key will undergo an identical series of computational steps. Depending on the algorithm, a change of key may alter the computation only slightly. Since no algorithm and key combination is truly safe (a cryptanalyst attempting to decrypt a message armed with a powerful computer is limited only by the time required to try all possible permutations) and the algorithm of known schemes is essentially invariant, the security of an existing system often relies on the frequent, often daily, change of keys.

Various schemes have been proposed to alleviate the disadvantages of prior art arrangements by increasing the complexity of any given algorithm. An example is the scheme described in U.S. Pat. No. 5,742,686 to Finley. This document suggests a device and method for dynamic encryption wherein different encryption and decryption programs are selected and executed optionally repetitively on the basis of a stored data set, which serves as the cipher key. While this prior art scheme allows the creation of custom encryption and decryption codes on a per user basis, the encryption algorithm used by each user will be invariant, and the complexity of this algorithm will depend directly on the strength and number of encryption and decryption codes utilized.

In U.S. Pat. No. 5,365,589 to Gutowitz a scheme for encryption, decryption and authentication is described that utilizes dynamical systems, that is, systems comprising a set of states, and a rule for mapping each state forward in time to other states. The dynamical systems employed are cellular automata. A collection of cellular automata is used as secret keys for the system. Initially a subset of this collection is selected for encryption, and the message to be encrypted is encoded into the current states. The selected keys are applied over a predetermined number of cycles and the resulting current states constitute the ciphertext. While this scheme is based on cellular automata it may not be considered truly dynamical because the number of iterations of the rules of the current key or keys is a fixed quantity determined in advance. The complexity is dependent on the number of keys or rules applied in any current encryption, and whilst it is possible to apply several rules in any single encryption, this is not always practicable. Furthermore, the inclusion of some reversible dynamical systems as current keys may introduce a weakness in the system.

Other examples of prior art are given by the documents EP 0 406 457 A1, U.S. Pat. No. 4,157,454, EP 0 759 669 A2, U.S. Pat. No. 4,608,456 and Kaliski B S JR et al: On differential and linear cryptanalysis of the RC5 encryption algorithm” ADVANCES IN CRYPTOLOGY —CRYPTO '95. 15TH ANNUAL INTERNATIONAL CRYPTOLOGY CONFERENCE PROCEEDINGS OF CRYPTO '95, SANTA BARBARA, CALIF., USA, 27-31 AUG. 1995, ISBN 3-540 60221-6,1995, BERLIN GERMANY, SPRINGER-VERLAG, GERMANY, PAGES 171-184 XP-002096305.

It is thus a general object of the invention to provide a system and a method increasing the useful life of an existing cipher system while minimizing the costs for changing the cipher systems. In particular, the invention seeks to provide a system design complying with applicable rules for example according to existing standards, security approval or legislative conditions.

### SUMMARY OF THE INVENTION

According to the invention the object is achieved by a system for encryption, arranged as a key generator for an existing cipher system. The key generating cipher system is connectable to the cipher key input of the existing key system and arranged to perform a key generation, which at each occasion of key output preferably generates a new key. Thereby new cipher keys are constantly generated and the security in the total system increases without changing the existing cipher system, since a possible crypt analyst has to reveal every new key to be able to decrypt a message. Repeated key generation is carried out dependent on predetermined conditions or dependent on a selected or for that purpose arranged control signal.

In a particularly advantageous embodiment of the invention a system for dynamic encryption according to the description below is arranged as a key generator with an existing cipher system. The system for dynamic encryption is thus coupled to the cipher key input of the existing key system and arranged to successively generate a new key, for example a new key for each occasion of key output. With this embodiment the security is further increased, since cipher keys are generated in a theoretically as well as practically unpredictable manner, as distinguished from other encryption methods, the security of which first and foremost is appraised based on the time the have remained uncracked.

In further preferred embodiments of the invention a new cipher key is generated for each new message or even for each part of a message. Thereby the value of a possible cracking of a cipher key is dramatically reduced, since the amount of information protected by each key is also dramatically reduced. Furthermore, the work of breaking the cipher is more difficult since more ciphertext is available for analysis of each key.

An embodiment of the invention is furthermore arranged such that a cipher key is generated dependent on the plaintext messages.

According to one aspect of the invention there is provided an arrangement for converting information from a first format into a second format, comprising

a memory for storing data,

means for updating the memory with input information,

an instruction table comprising a set of operations adapted to modify the state of the memory,

processing means adapted to select operations from the instruction table in response to at least part of the input information and to execute the selected operations on the contents of the memory,

at least one of the set of operations being selectable in response to any possible configuration of at least part of the input information, and

means for extracting output information from the memory.

According to another aspect of the invention there is provided a method for the conversion of information from a first format into a second format comprising:

establishing a set of operations for modifying the state of a memory,

storing input information in a first format in the memory,

selecting operations from the set in response to at least part of the input information and executing the operations on information stored in the memory, wherein the set of operations is devised such that an operation will be selected in response to any possible input information stream, and

extracting information from the memory in a second format after executing at least one operation.

A characteristic of the method and apparatus according to the present invention is that the process by which the input information is encoded depends entirely on this input information. Specifically, both the sequence and the number of operations executed is defined by the information to be encoded. The input information essentially serves as a program for its own encryption. Consequently, the process cannot be described in terms of an algorithm because by definition it must differ for each different input information stream. Even with knowledge of the structure of the arrangement or the steps of the method according to the invention, the actual process executed will be indeterminate until information is actually supplied. This has the advantage that the process executed cannot be described or determined without knowledge of the input information. Furthermore since each freshly selected operation will be carried out on the accumulated results of previously input information stored in memory, even partial knowledge of the input will not facilitate reconstruction of the actual process executed because the output will be a function of all the input.

A further advantage is that inputting random information will necessarily generate a random output, since both the operations executed and the information on which the operations are performed will be random.

In a further aspect of the invention the aforementioned arrangement is included in a system for the encryption and decryption of message data comprising a cipher device, the cipher device being adapted to receive message data and at least one cipher key and to generate encrypted data corresponding to an encryption of the message data, wherein the output data extracted from the data processing arrangement is the cipher key.

In a still further aspect of the invention the aforementioned method is utilized in a method for the encryption and decryption of message data including utilizing the information extracted from the memory as a cipher key and encrypting the message data with a cipher function and the cipher key to generate encrypted information.

By utilizing the arrangement and the method according to the invention as a cipher key generator for a cipher primitive, the overall strength of the cipher primitive can be substantially increased. Not only will the generation of a key be a highly complex process but, in addition, several different keys can be generated and used for the encryption and decryption of a single message. This permits the security of any known cipher system be substantially improved and has the added benefit of eliminating the need for the communicating parties to have access to a large collection of shared keys.

Definitions

In the present description the established terminology in the technical field is used, such as plaintext meaning an information message that is not encrypted, and ciphertext for an information message that is encrypted according to any encryption function. Plaintext and ciphertext, respectively, refer to an arbitrary form of information or data, for example text, numerical information, image information, number signals, control or communication signals.

In the description, the expression communicatively coupled is used to describe, independently of the implementation, the coupling between two units for the exchange of data signals through a signal connection or a data bus as in a hardware implementation, or parameter values or other information between parts of a software program in a software implementation.

### BRIEF DESCRIPTION OF THE DRAWINGS

Further objects and advantages of the present invention will become apparent from the following description of the preferred embodiments that is given by way of example with reference to the accompanying drawings, in which:

FIGS. 1-7 show embodiments of the technology upon which the invention is based;

FIG. 8 shows a block diagram schematically depicting the principle of an encryption apparatus;

FIG. 9 shows schematically a general embodiment of the invention;

FIG. 10 shows schematically a further embodiment of the invention;

FIG. 11 shows the internal structure of the key generator according to an embodiment of the invention;

FIGS. 12A-12F show different embodiments of and ways of implementing an extensive memory according to an aspect of the invention;

FIG. 13 shows an embodiment of a feedback unit comprised in an embodiment of the invention; and

FIGS. 14A-14E and 15 show schematically different functional units comprised in embodiments of the feedback units according to the invention.

### DETAILED DESCRIPTION OF EMBODIMENTS OF THE INVENTION

Apparatus for Generating Keys to the Cipher Systems

In FIG. 8, a first cipher apparatus or cipher unit 110 is schematically shown, which apparatus has an input 801 for plaintext, that is messages in the shape of encrypted data or any kind of information, an output 802 for ciphertext, that is the plaintext message in an encrypted form and an input 803 for a cipher key. According to the invention and as shown in FIG. 9, said first cipher apparatus is combined with a key generator 930 which is communicatively and possibly galvanically coupled to the input for the existing key 903, henceforth called internal cipher key (IKEY). A reduction of the amount of the plaintext that is protected by each internal key is reduced due to the fact that the key generator 930 generates internal keys to the first cipher system 910. The key generator 930 is provided with an input for an external cipher key 908, which thus is the key indicating the function by means of which the internal key is generated and thus also the function by means of which the plaintext is encrypted. Repeated generation of internal keys occurs dependent on predetermined rules, which may be implemented in the key generator itself or dependent on a synchronizing signal from a clock or from the cipher unit that directly encrypts the plaintext message.

In a preferred embodiment of the invention the key generator 930 is actually a self-contained cipher system, and preferably a cipher system according to the description below. The latter is particularly advantageous from the technical effectiveness point of view, since no single encryption algorithm is selected for key generation, but differently and randomly selected encryption methods are generated in the key generator as it is used.

It is generally true that if the internal cipher key is changed sufficiently often, that is when the stream of plaintext information is less than or equal to the stream of internal key information, the security in the total system cannot be lower than the security achieved in the key generation system 930. According to a first embodiment of the invention, a new key is generated for each key output from the key generator 930. In a second embodiment, in which the first cipher system 910 is a block cipher system a new key is generated for each block that is encrypted. Further ways to vary the key generation according to the invention is described below.

FIG. 10 shows an embodiment in which a synchronization is arranged between the key generator 930 and the cipher apparatus 1010 by means of a synchronizing unit 1020. The synchronizing unit 1020 is thus communicatively coupled between the key generator 1030 and the cipher apparatus 1010 such that a synchronizing signal SYNC can be communicated from a synchronizing output 1004 of the cipher apparatus 1010 to a synchronizing input 1012 of the key generator. It is also arranged such that a generated internal cipher key IKEY can be communicated from the key generator 1030 to the cipher apparatus 1010 either directly or through the synchronizing unit 1020. In the embodiment according to FIG. 10 a signal is received in the synchronizing unit 1020 from the cipher apparatus 1010 when the internal cipher key should be changed, and the synchronizing unit then sends a new internal cipher key IKEY via the cipher key input 1003 to the cipher unit 1010. In the same way the synchronizing unit 1020 may be arranged to operate with the key generator 1030, whereby the synchronizing unit 1020 sends a synchronizing signal to the module 1030 when a new key is needed. In one embodiment the synchronizing unit 1020 is designed as or comprises a key buffer 1022, which gives the advantage that the key generator 1030 can operate in parallel with the cipher system 1010. In another variety of the invention the synchronizing unit 1020 is implemented without this buffer function, by enabling the key generator 1030 to give the key directly to the cipher apparatus 1010 in the same way as is shown in FIG. 9.

FIG. 11 shows an implementation of a key generator 1130 according to the invention in which an external key EKEY is input to the input 1114, and the completed key IKEY is input to the cipher system 910, 1010 (not shown in FIG. 11) which encrypts the actual message, i.e. the internal key IKEY is output from the out put 1116. The external key EKEY at the input 1114 provides the memory 1133 with a seed. Thereafter different cipher operations are executed in a data processing means 1132 on the content of the storage 1133 and controlled by a program in a program memory 1131. The program memory 1131 is communicatively coupled to the data processing means 1132 via the signal path 1103, and the data processing means 1132 is in its turn coupled to the memory 1133 via signal paths 1102. A part of the content in the memory 1133 is further transferred as a first processing material via a signal path 1135 to feedback unit 1134. The feedback unit 1134 performs in this embodiment on one hand a combination of linear and non-linear operations on said first processing material, and on the other hand combines this first processing material with previously obtained processing material from one or more preceding steps of operation. From the feedback unit 1134 a completed internal cipher key is then output at the output 1116 to the cipher apparatus 910, 1010. A signal path 1104 is further arranged from the feedback unit 1134 to the program memory 1131 which is thereby updated with output data from the feedback unit 1134, so that the program controlling the data processing means 1132 is continuously changing during operation.

According to preferred embodiments of the invention the data processing means 1132 is conveniently designed such that it directly produces an internal cipher key on the format required by the cipher apparatus 910, 1010. It may then be advantageous to use a separate transfer from the data processing means 1132 to the program memory 1131, since the program memory 1131 may require a different format than the format the cipher apparatus 910, 1010 is arranged to receive. Preferably, it is also arranged such that the traffic volume on the internal cipher key output 1116 is less than the traffic volume internally used on the signal paths 1104 and 1105 in the key generator 1130.

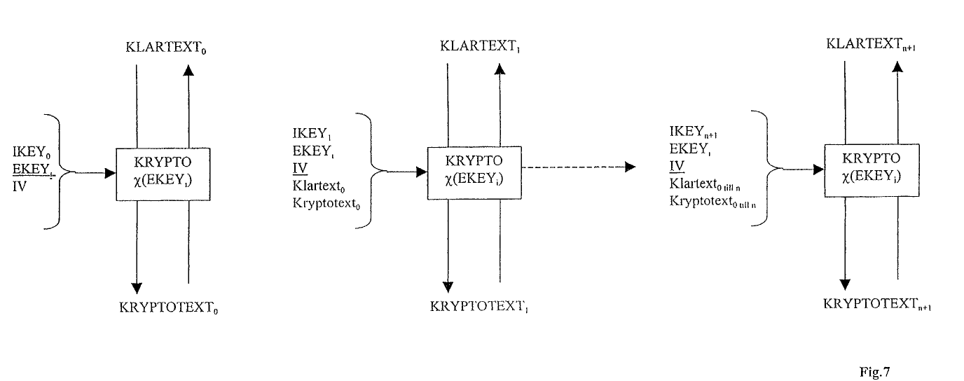

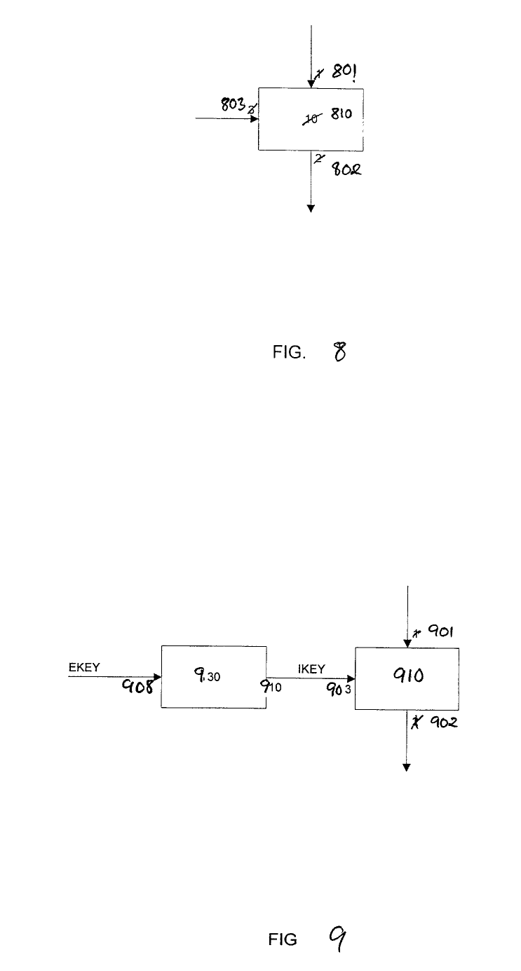

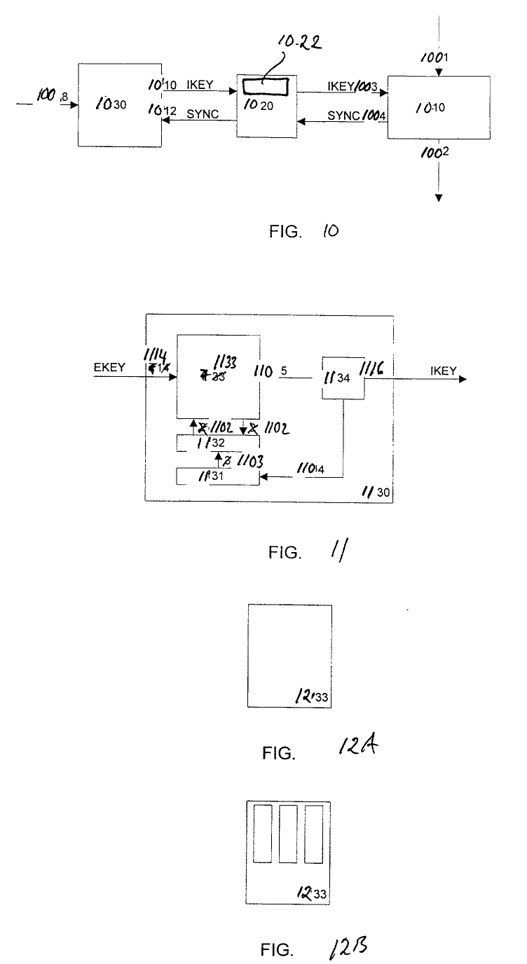

The memory 1133, which is schematically shown in FIG. 11, is arranged to store status information to the key generator 1130. The memory 1133 can be implemented in several different ways, examples of which are shown in FIG. 12A to 12F. More specifically FIG. 12A shows a general implementation of the memory, according to which a large memory with a fixed size is used. According to the example shown in FIG. 12B and according to the appended description of a cipher system, the memory 1233 is implemented as a plurality of stacks. FIG. 12B shows as an example three stacks, but other numbers of stacks are also conceivable. In FIG. 12C the memory 1233 is implemented in the large memory having a fixed size. A particular arrangement is used to practically realize a memory of variable size. When operations in the data processing means 1132 are executed on the content of the memory 1133, 933 the part of the memory that is dashed is used. A memory having a size which is not fixed but instead is enlarged as the operation continues is realized by successively using a larger portion of the total memory in FIG. 12C. In FIG. 12D the memory 1233 is realized as a real memory with a variable size.

A significant problem in practical use of encryption is the fact that a large amount of different data communication connections should be handled, which connections each uses encryption realized according to the invention or according to other methods. It is conceivable to use a computer central communicating with a plurality of different geographically distributed units, or an application simultaneously using several different encrypted communication connections. Another example is an apparatus executing several different applications, each of which having a connected encrypted communication connection. In applications where a large number of different encrypted communication connections occur, each having its own cipher key, it is advantageous to realize the memory 1233 as shown in FIG. 12E.

FIG. 12E shows a memory 1233 which is divided into two separate parts labeled A and B, respectively, which are connected to a cross connection unit 40. The memory parts 1233A and 1233B are preferably realized according to one of the alternatives in FIG. 8A to 8D. The data processing means 1232 uses the memory 1233A and 1233B, respectively, by sending calls via the cross connection unit 1240, which connects the calls with one of the modules 1233, for example 1233A. The other one of the two memory parts, here 1233B, is connected by the cross connection module 1240 to a memory means in the shape of a cache unit 1250, said cache unit comprising a memory 1252 large enough to simultaneously store status information for the plurality of simultaneous connections which may be relevant for the cipher unit according to FIG. 9 or FIG. 10. The cache unit 1250 includes a control unit 1251 which systematically calls the memory part 1233B (in this example) and transfers all data from memory part 1233B to the cache unit 1250. Thereafter the control unit transfers data for another connection to the module 1233B. Assumed that data in the memory part 1233A corresponds to a connection or a channel U1 and data in memory part 1233B corresponds to a channel U2, the status information to channel U2 has been saved in the memory 1252 and some other status information, for example for U3, has been loaded into the memory part 1233B. When the cross connection unit 1240 switches the memory part 1233A and 1233B, synchronized with the cipher unit changing encryption of data on channel U1 to data on channel U3, an implementation of a memory with variable size is achieved (and then also of the entire module 1230) where the status information can be changed instantaneously. The often resource demanding change of status information is thus transferred to the memory 1252, which should have a suitable dimension. This is implementable to an acceptable cost, assumed that a suitable configuration has been provided such that the control unit 1251 is able to save and change the content in the module 1233B before a switching of the status information is requested. The schema tic drawing in FIG. 12F shows how the information paths are switched in the cross connection unit. It is preferably arranged such that the status information in the feedback unit 1134 (see FIG. 11) either is stored or is wasted in order to enable a correct synchronization.

The purpose of the feedback unit 1134 is to read in the memory 1133 and to convert this information to a cipher key. In order to meet requirements on resistance against cracking the key generator 1130 is preferably implemented such that the feedback unit 1134 reads more information from the memory 1133 than the amount of memory sent from the feedback unit 1134 to the program memory 1131 and to the output 1116 in FIG. 11. Preferably, the flow of information should be two to ten times higher at the input 1105 to the feedback unit 1134 than at the outputs 1104 and 1116. In order to further protect the content of the memory 1133 against cracking attacks a protective function is implemented in the feedback unit 1134, 1034 (see. FIG. 13), which can consist of a functional unit 1362 comprising a linear feedback, a non-linear feedback or, which is preferable, a combination of a linear and a non-linear feedback. The purpose of a non-linear feedback is to complicate cracking of the key generator 1130, while a linear feedback mainly improves the statistical properties of output data from the feedback unit 1134, 1034. FIG. 13 shows a schema tic configuration of the feedback unit 1334, which comprises a feedback memory 1361 consisting of a memory, which aims to render the possibility of a feedback of previous output data from the feedback unit 1334. The memory can comprise a single block of output data from the feedback unit 1334, or several blocks of output data. The advantage of using only a single block of output data is that this information can be more easily stored in connection with a possible temporary change of cipher keys, as has been previously described above. If several blocks of output data are stored in the feedback memory 1361, there is the possibility of more varied and better feedback, which is valuable if good statistical properties are desired. The feedback memory 1361 is realized in FIG. 13 as a stack, where the elements stored in the feedback memory 1361 are moved one step upwards when a new element is to be added via the connection 1304 in FIG. 13. The uppermost element in the feedback memory 1361 is lost and the bottom element of the feedback memory 1361 in FIG. 13, which becomes vacant, is used to store the new element from the connection 1304. The feedback memory 1361 is provided with a plurality of outputs, labeled with 1302 and coupled to the functional unit 1362, which in its turn has a feedback connection with the connection 1304. The connection 1304 is also coupled to an output stage 1363 outputting the result on the output 1306. If the memory capacity in the feedback memory 1361 is large, the time delay occurring between the input and a certain connection should preferably be prime in relation to the other time delays from the other outputs. The easiest way to realize this is by arranging the feedback memory such that the time delays are indicated by prime numbers.

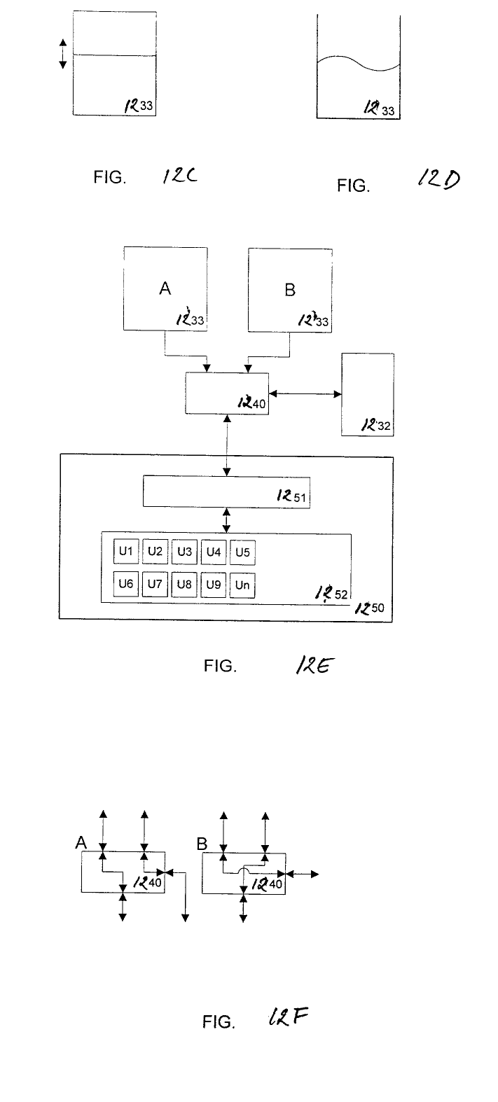

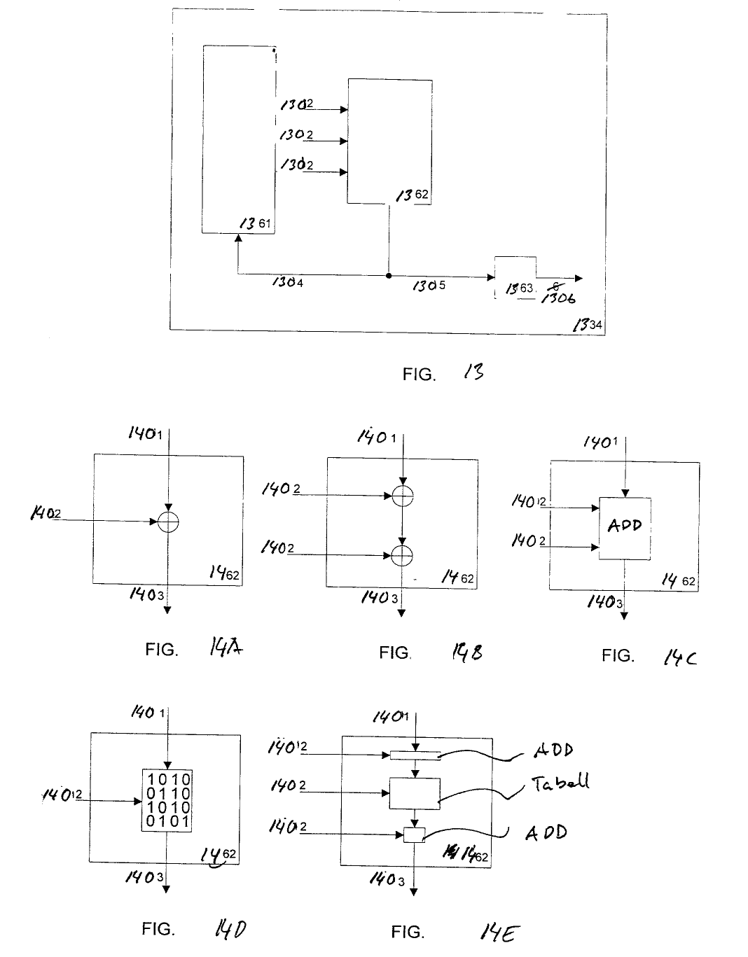

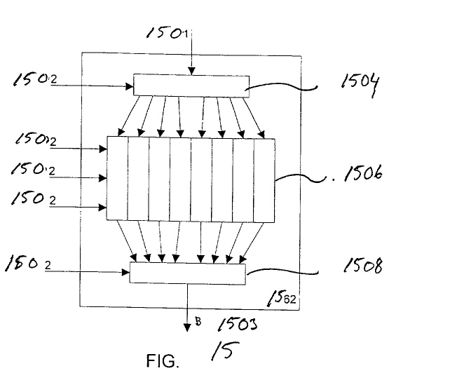

FIGS. 14A to 14E show some examples of embodiments of the functional unit 1362 realizing a linear or a non-linear function of input data to output data. FIG. 14A shows how output data from an embodiment of the functional unit 1462 is a linear function of input data (XOR) from the inputs 1401 and 1402. FIG. 14B shows a possible implementation having a plurality of inputs to the functional unit 1462 from the feedback memory 1361. FIG. 14C shows a conceivable implementation of the functional unit 1462 where the incoming numbers are added in their entirety (ADD), as compared with FIG. 14A where the numbers are added bit by bit (XOR). In FIG. 14D the functional unit 1462 implements a non-linear function with the aid of a table. In order not to introduce any statistical error the number of ones and zeros in the table is equal. It is advantageous to implement the table in some other number system than the binary system, and in that case all the numbers should occur an equal number of times. In connection with FIG. 14D it should be noted that the table should be changed quit often. This can be implemented by re-arranging the numbers of the table or by generating entirely new tables during operation. In the embodiment according to FIG. 14E there is implemented in the functional unit 1462 a combination of functions where three signals from the feedback memory 1361 are used. The uppermost signal and the bottom signal are used for an addition operation according to FIG. 14D, and the middle signal is used in a table operation according to FIG. 14D.

FIG. 15 shows a more complex implementation of a functional unit 1562. At the top there is a select operator 1504, which selects one of several possible operators. In the middle there are a number of different operators 1506, schematically shown as a list. The select operator outputs its output data to an addition operator 1508. The select operator is, if the operators are different, generally an non-linear operator. It is advantageous to select the operators in the list as different non-linear operators.

Detailed Description of the Encryption Functionality

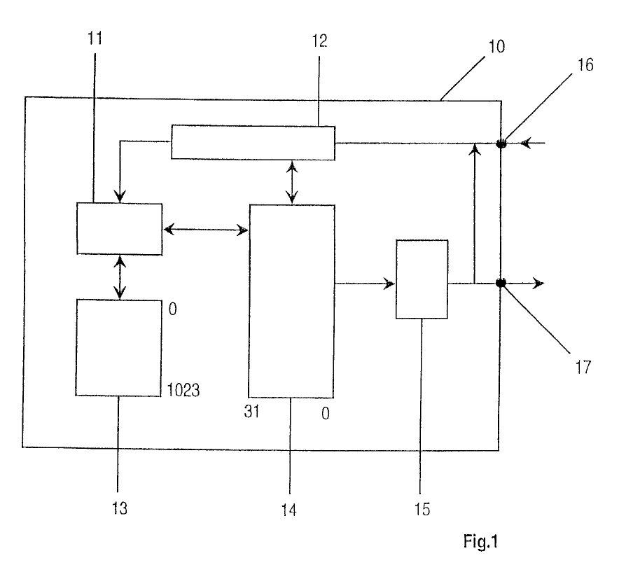

A machine or apparatus module embodying the present invention is shown in FIG. 1 by reference numeral 10. The module 10 comprises a processor 11, a program memory 12, an instruction memory or lookup table 13, and a general purpose memory 14, which preferably should be accessible at least partially randomly. An input port 16 and output port 17 are provided for inserting and extracting information, respectively and an output register 15 is included between the general purpose memory 14 and the output port 17.

The input information, which in the preferred embodiment is in the form of a binary string, is input into the program memory 12. This memory 12 preferably has a large capacity to enable as much as possible of the input information to be accessed as program, as will be explained below. The instruction table 13 holds a predetermined set of instructions or operators (opcodes). These operators are addressed using sections of the input information stored in memory 12 as addresses or indexes to the table 13. Hence the input information essentially serves as a program according to which the processor 11 executes the operations of the instruction table 13 on data in the memory 14. The number of operators stored in the instruction table 13 is chosen to correspond to the size of the input information sections serving as program steps, so that every possible permutation of input numbers accesses a valid operator. In other words, any possible string of input numbers, in this case, any possible input binary string, is a valid program. In the exemplary embodiment, the processor 11 reads 10 bits of the stored input information at a time as a program step. This information could have any value between 0 and 1023. Hence to ensure that any possible input string will enable the processor 11 to select a valid operation, the instruction memory holds 1024 operators. The operators are preferably different and mutually independent so that no two different input strings will cause an identical sequence of operations.

Whilst in the embodiment described with reference to FIG. 1 the number system used for storing and manipulating the information is binary, which advantageously permits the use of a digital processor, it will be understood that any number system may be used according to the needs of the implementation of the module 10 and the application requirements.

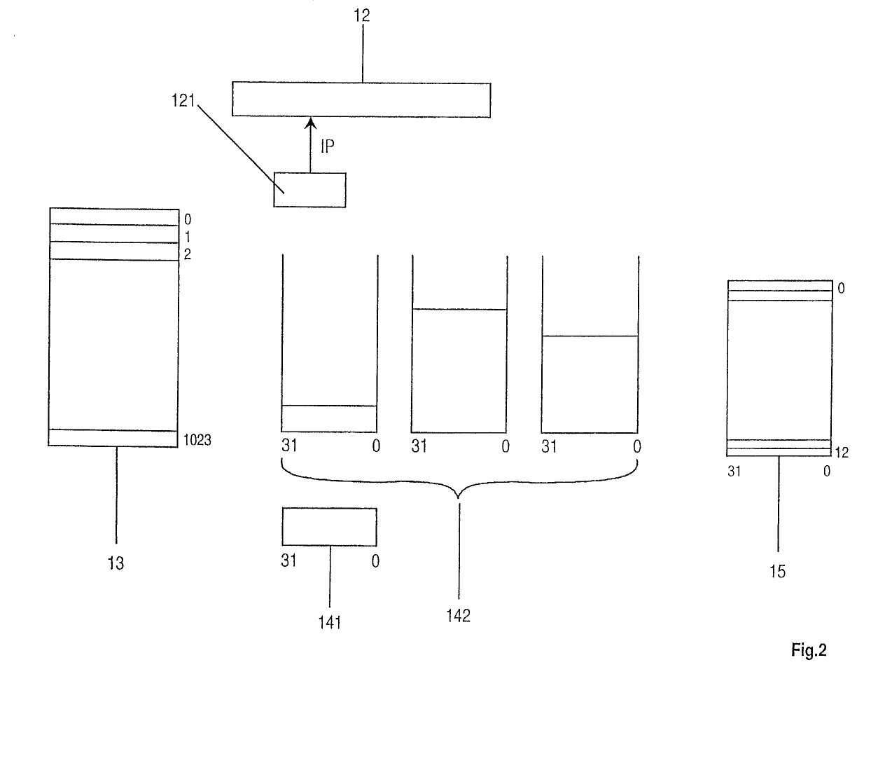

An instruction pointer (IP) (shown in FIG. 2) is associated with the program memory 12 and used by the processor 11 to select the address of operators contained in the instruction table 13. The program steps constituted by the input information may be selected in a step-wise fashion from one end of the information to the other, however the processor 11 is preferably capable of controlling the pointer IP to select a program step from any portion of the information input. This in turn implies that the program memory 12 must have a capacity large enough to allow access to any section of a large amount of input information. The instruction table 12 preferably permits read and write operations to enable the order of the instructions, that is the addresses of each instruction, to be changed. The instructions themselves are chosen to change the state of the memory 14 in some way. The instructions typically include, but are not limited to, fast operations such as add, subtract, table lookup and slow operations such as integer multiply and iterations. However it is important that the instructions are limited to operate on areas of memory 14 containing data and that instructions that may arrest processing are excluded. The operations in the instruction table 13 are selected to update the memory 14 and thereby change the state of the module 10 only.

In the preferred embodiment, data is processed in units of 32 bits. Accordingly, the general purpose memory 14 holds 32-bit words, and is of a size sufficiently large to ensure adequate complexity in the generation of the output data. It should be noted that to achieve maximum complexity for any fixed number of operations, full computability should be provided. This requires that the memory be extensible, that is, it should have a size that can be altered during processing to avoid the necessity of rounding-off. It should be noted that rounding-off may cause to two different operations to produce the same result and accordingly limits the possible processing diversity of the module 10.

In FIG. 1 a bi-directional connection is schematically shown between the program memory 12 and the general purpose memory 14 to indicate that data may be exchanged between the two. Specifically, when inputting data, this information can be fed both to the program memory 12 and to the general purpose memory 14. Hence input data serves simultaneously as program and operand, and the output data will contain traces of input data that has been transformed by the program. Similarly, data from the general purpose memory 14 could be pulled into the program memory 12 and used as program. It will be understood that the initial content of the general purpose memory 14 depends on the particular application of the module 10. This will be discussed in more detail below.

The output register 15 serves to buffer blocks of output data extracted from the general purpose memory 14. The output register 15 is structured with a number of rows. In the preferred embodiment, the register 15 contains 13 such 32-bit rows. The output data is read from predetermined locations in memory. For example, if the memory were implemented as a number of stacks (see discussion below) the output data could be taken from the top of the stacks.

The extraction of output data could occur periodically, for example after the execution of a predetermined number of operators. This could be implemented using a counter and stop flag that can be updated by the processor 11. The stop flag is preferably a specific location in the general purpose memory 14. However, the extraction of output data should preferably be dependent on the input information in the same way as the processing of this information. In other words the point in time at which the stop flag will be set should be indeterminate prior to supplying the input information. Specifically, the point in time at which extraction is enabled is determined by the occurrence of a number of selected operators or the contents of a particular location in memory, or a combination of the two. This is implemented in the module 10 by providing a stop flag that can be consulted by the processor 11 at intervals, for example after every operation. The stop flag is a reserved portion of memory 14. At least one of the operators contained in the instruction table 13 updates the stop flag when it is executed. Such an update will not normally consist of setting the stop flag to “stop” but rather to assign “stop” only if some condition is met by some data. Each individual operation that updates the stop flag, are preferably devised to do this in different ways.

Preferably several of the operations will be adapted to update the stop flag. When the stop flag is set, data is output onto the output register 15 from at least one specific location in memory. The specific location or locations may be pre-defined or be dependent on the operators called. In addition, specific operations may be performed on the output data prior to its transfer to the output register 15. These additional output operations are preferably selected from a plurality of possible operations selected according to the value of a predetermined location in the general purpose memory 14.

It will be understood that the updating of the stop flag need not be limited to the description given above. However, it is important that certain conditions are imposed on the generation of the stop flag to reduce the risk of data being extracted after undergoing only very few operations.

It should further be noted that the calling of the stop flag need not arrest processing. While in a software implementation of the module 10, it is convenient to permit the processor to consult the stop flag after the execution of each operation, it will be understood that this could be done in parallel with the execution of operations. It is further evident that if the output operation were implemented entirely in hardware, the triggering of output data extraction could be independent of the functions of the processor.

The register 15 may output data in a block of equivalent size to that of the input blocks, of a larger size, or of a smaller size.

The module 10 may also include a feedback connection between the output register 15 and the general purpose memory 12 so that output is also used as program to process the contents of memory 14. This provides added security and reduces the risk that some of the data in the output register does not change from one extraction to another. Also the final output extracted by the output register 15 will then be a function of both the information input and information output. Depending on the application of the module 10, it may be advantageous to iterate this feedback operation for at least a predetermined number of times.

Optionally there can be provided a direct input connection (not shown) to the general purpose memory 14, to enable the initial state of this memory to be set externally. It will, however, be understood that the general purpose memory 14 could be at least partially filled with initializing input data via the input port 16 and the program memory 12 under control of the processor 11.

While in FIG. 1 there are schematically depicted various individual elements and connections between individual elements of the module 10, it will be understood that the implementation of the individual functional elements and the exchange of data between these elements may be achieved in different ways. In particular, a single random access memory could be provided for storing the input data program, the operand data and possibly also the operators of the instruction set and their addresses. In order to obtain extensible memory, it is preferable to implement the memory 14 as at least one stack and possibly also at least one register, to enable data to be transferred from stack to register or vice versa. However, full computability, i.e. the capability to simulate any possible machine, will be enabled only when at least two stacks are provided. An equivalent level of computability would be provided with a bi-directional readable and writeable tape.

In another wording, the definition of full computability in a data processing device may also be expressed as the device being capable of, given a suitable program, simulating any computational process. Such a data processing device is most often referred to as a computational machine being capable of universal computation.

FIG. 2 shows a preferred implementation of the memory elements of module 10 wherein the various interconnections are omitted. In this figure, elements similar to those shown in FIG. 1 have like reference numerals. In common with FIG. 1 the arrangement according to FIG. 2 comprises a program memory 12. A program register 121, which in the preferred embodiment has a capacity for addressing a 10-bit word, is associated with the program memory 12 and serves to hold the current program step selected by the instruction pointer IP. The instruction pointer is controlled by the processor 11(FIG. 1). As mentioned above, the size of the program memory depends on the manner in which input data is used to select operators. Ideally the program memory 12 should be large enough to store an entire input message, so that the processor may select an instruction from any part of the message. In practice this may be problematic and costly, however, to enable a reasonable simulation of full computability it is preferred that the program memory has a capacity for at least 100,000 bytes. The instruction table 13 is the same as in FIG. 1 and is adapted to hold 1024 instructions that are accessed by means of the information in the program register 121. The general purpose memory 14 of FIG. 1 is replaced by three stacks 141, each adapted to hold 32-bit words, and at least one register 142. The implementation of the memory with stacks permits the memory to grow as the processing proceeds and accordingly substantially enables full computability. The stacks 141 could be empty initially and filled progressively with input data as the input sequence is fed into the module. Alternatively, and depending on the application, the stacks 141 could be initialized with a random number sequence or any predetermined number sequence. The register 142 serves to extend the instruction set and specifically is used to temporarily store data when the stacks are updated. With the memory implemented as shown in FIG. 2, the instructions contained in the instruction table 13 can include operations to transfer data between two stacks 141, between a stack 141 and the register 142, operations on data contained in the stacks 141 and the register 142, and an operation that may alter the order of other operations. If more than one register 142 is provided, valid operations could also include transfers between registers.

In order to ensure a high complexity in the process, it is preferred that the number of available instructions is at least of the order of 500 and that the memory 14 is at least 100,000 bytes in length. If the memory is implemented in the form of stacks and registers, it is preferred that registers with capacity of at least 150 bits and at least three memory stacks are available. One way of characterizing embodiments of the invention is by the requirement that the operations in the instruction table comprise such a large number of different operations that all combinations of said instructions can be simulated only by a data processing device having full computability. The least theoretical number of operations achieving this requirement is limited to a few suitably selected different operations.

The arrangement shown in FIGS. 1 and 2 represent the functional structure of the module 10 according to the present invention. It will be appreciated that this function may be implemented in a number of different ways. A hardware implementation could involve the use of a microprocessor with an associated non-volatile memory containing mapping between the selected program steps represented by the input data and the predetermined instructions, and random access memory (RAM) for storing the input program, the data used as operands and the output data. The entire module 10 could also be implemented in software. This has the advantage that the size of the program steps and the number of available operations can be changed more easily and accordingly be adapted to any specific application. A software implementation of the module would preferably be stored on a non-volatile memory, such as the hard disc of a computer, or even on a machine-readable storage medium such as a set of diskettes, CD ROM or tape for use with any data processing machine. The program could also be made available through transmission over a telephone line, on the Internet or via other communication means, by modulating a carrier signal with information representing the program.

While it may be possible to implement the functions of the data processing module 10 on any general purpose computer, this would entail the incorporation of a number of essential modifications. In particular, in the module and method according to the present invention all possible input data strings must be interpreted as valid program and be capable of addressing a valid instruction. This is necessary to prevent unauthorized instructions from terminating execution of the program and limiting the complexity of the module's function. Most general purpose computers also have a minimal set of operations where each operation perform an atomic operation only. The present invention could use an operation list of more complex kind, where each selected operation perform a series of state changes, as compared to a single state change for the well-known general purpose computer. Furthermore, the processor must be prevented from accessing extended virtual memory. Since any selected instruction must be valid, instructions such as JUMP and MOVE must be limited to areas of real memory if they are to be authorized. Finally, all instructions that arrest processing, such as a HALT instruction, or output data on a screen or printer must be excluded from the instructions set. In this respect it is important to note that the module 10 is not intended to output data in the conventional sense as part of its normal execution. It merely operates to update internal memory. In this respect, the output register 17 can be viewed as external to the processing of module 10 as such, since it extracts selected portions of the memory at intervals during operation without influencing the contents of the memory.

The module 10 is a data processing device wherein the state generated during execution cannot be predicted prior to execution. The process evolves differently for each possible input string. In other words, the process performed by the module cannot be described by an algorithm. This function has a number of useful applications, particularly in the field of cryptography. The operation of the module 10 for some of these applications will be discussed below.

Random Number Generator

As mentioned above, the sequence of operations performed by the module 10 depends on the input information. Hence inputting a random number sequence, commonly called a “seed”, will be interpreted as a program of random operations and consequently generate a random output.

Random number generators have many uses. An example is the generation of weekly lottery numbers. Another application would be in the area of Monte-Carlo simulations, or as a random number generator for Genetic Algorithms or Simulated Anneling. An important further application is the generating of cipher keys for the encryption and decryption of information.

The initial input sequence should be obtained from a high quality random noise source, such as the SG100 hardware noise generator manufactured by Protego Information AB, Malmö, Sweden.

Prior to operation, the general purpose memory 14 of the module 10 will be at least partially filled with a random sequence. This sequence may be the seed itself which would then be loaded simultaneously into the program memory 12 and general purpose memory 14. Alternatively a separate random number may be used. This has the advantage that a larger initial sequence could be used to define the state of the general purpose memory 14 than is needed or desired as a seed. The seed would then be input into the program memory 12. For this application, the seed could be input in its entirety, and the instruction pointer moved stepwise through the sequence, selecting the corresponding instruction as it moves. As an instruction is selected, the data contained in the general purpose memory 14 will be updated in some way defined by the operation. A number of operations contained in the instruction table 13 will also update the stop flag that is represented by a location in the memory 14. The value of the stop flag will be checked at intervals, possibly after the execution of each instruction, and when it is found to be set, data contained in specific locations in memory will be read out to the output register 15 as random output.

The module 10 should preferably be capable of generating a large number of different keys from a single seed. This may be achieved simply by repeating the program defined by the seed. Preferably, however, the program will not be limited to the steps defined in the seed but will also use other data as program. For example the contents of the general purpose memory 14 might be used. This may be implemented by automatically loading the program memory 12 from a specific location in the general purpose memory 14 once the instruction pointer IP has stepped through seed, or when the program memory is empty. As a further possibility, any data extracted as a random output could also be fed back into the program memory 12. However, to reduce the likelihood of some of the output data being unchanged between extractions, the whole process should be repeated at least once with the last generated key serving as input data before the random number output is actually produced. In this way, the amount of random output that can be generated will be limited only by the run time of the module 10.

One Way Hash Function

It will be apparent from the nature of the module 10 that its function is not reversible. In other words, the module will not generate input information from the corresponding output data. As discussed above, the output string length can be fixed while the input string length may be variable. The module 10 can thus be used as a one way hash function. Other names for this function include compression function, contraction function, message digest, fingerprint, cryptographic checksum, message integrity check (MIT) and manipulation detection code (MDC).

For this application a feedback connection between the output register 15 and the program memory 12 may not be necessary. In its simplest form, a one way hash function could be implemented by initially loading the general purpose memory 14 with a predetermined bit stream, for example alternate 1's and 0's. The message to be fingerprinted is then input into the program memory 12 and the processor executes all the operations until the message is terminated and then stop. The data contained in the output register would then be the checksum, or fingerprint, of the message.

In a further embodiment, the stop flag of the processor could be disabled and the processor be adapted to enable the output register 15 to extract information from one or more specific locations in the memory 14 only when the execution of the program is terminated. In this application, the size of the output register could be selected to provide a condensed fingerprint or checksum of the message.

If the verification of a message hash function is to be kept secret, a secret key can be used when computing the hash function. This is also known as Message Authentication Code (MAC). This assumes that the parties wishing to demonstrate and to verify the authenticity of a document share a secret key, or collection of secret keys, and some convention for selecting which key is to be used. In this case, the secret key could be used as the initial value of at least part of the general purpose memory 14, as a header to the message information, or employed to change the order of the operations in the instruction memory 13, i.e. their addresses, or a combination of any of these. Only a person in possession of the key used to generate the hash function can verify whether the message is authentic or not.

Encryption/Decryption

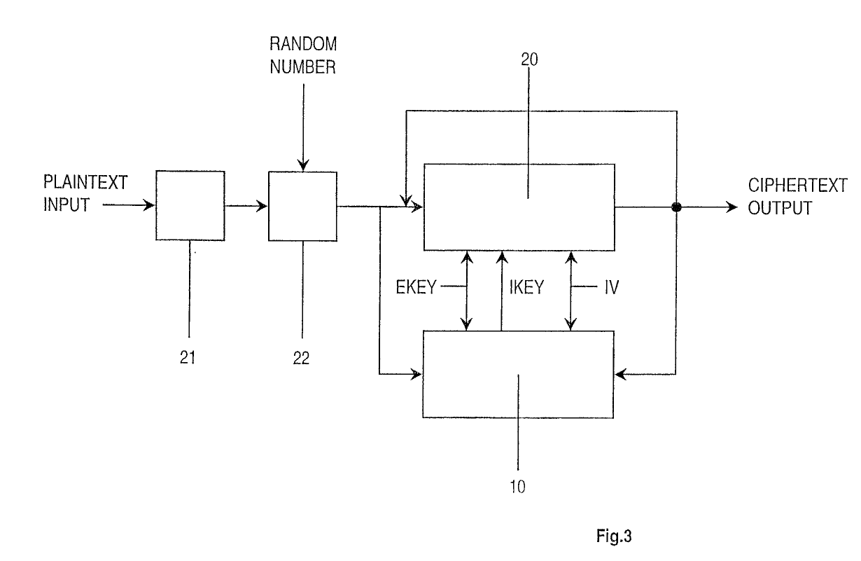

As already discussed above, the module 10 can be used as a key generator for a cipher system when fed with a random number sequence. In a preferred embodiment the module 10 is combined with a cipher primitive to generate a highly secure cipher function. The encryption and decryption arrangement is shown in FIG. 3.

In this embodiment, the module 10 is arranged in parallel with a further element 20 representing a cipher system. The cipher system 20 may be a simple cipher primitive such as substitution, or could embody any known block or stream cipher function. However it is preferable that the cipher system 20 utilizes an algorithm with a tried and trusted level of security. If the apparatus according to the invention is to be used as a random number generator, a stream cipher could be selected, and the encrypting sequence resulting from the stream cipher could be used as a random source.

As for any encryption and decryption scheme, a secret key shared between the person encrypting the information and the person authorized to decrypt the information must be utilized.

In the preferred embodiment described below, the cipher system 20 is a block cipher function adapted to use two keys to generate ciphertext. One key is a secret key EKEY shared between the parties; the other key IKEY is generated by the module 10. In the arrangement depicted in FIG. 3, the input message or plaintext is fed simultaneously into the cipher system 20 and the module 10. The module 10 generates an internal key, IKEY, and supplies this to the cipher system 20. The secret external key EKEY that is shared by the two communicating parties, or by parties authorized to access the encrypted information, is also input into the encryption and decryption arrangement and is used by the module 10 to generate the internal key IKEY. The cipher system 20 uses this internal key IKEY and also the external key EKEY to generate ciphertext. The ciphertext is output by the cipher system 20 on the right-hand side of the figure. The output ciphertext is also fed back from the output of the cipher system 20 to the module 10, and is utilized as program data to generate subsequent keys. In this way, the internal keys IKEY will be generated as functions of both the plaintext and the ciphertext.

A further feedback connection is provided between the output and the input into both the module 10 and the cipher system 20 to allow a message to be encrypted several times prior to storage or transmission.

Before being input into the module 10 and the cipher system 20, the message plaintext is preferably compressed using a compression function 21. Any known reliable compression function can be utilized. The compression serves to eliminate, or at least reduce, any periodic pattern in the message text sequence. This is advantageous particularly when several messages at least partially share the same format, such as a header having addresses, identification and checksum or the like, or carry a limited range of information, such as may occur for electronic money orders for instance. As a further precaution to ensure that no two plaintext messages will be the same, a random number is also added to the message text using a combiner 22. It will be understood that while in FIG. 3 the combiner 22 is shown as a separate element, this arrangement should be understood to indicate that the addition of random noise occurs prior to the functions performed in the module 10 and the cipher system 20. In a hardware implementation of the encryption and decryption arrangement, the combining function could be performed in either the module 10 or the cipher system 20, or even in both. As discussed above, a random number should be obtained from a high quality noise source. The combiner 22 preferably interleaves random numbers with the message text as will be described below.

Information is both read into the encryption and decryption apparatus and processed in words of 32 bits. Before information can be fed to the apparatus it is formatted into blocks. These have the generalized structure shown in FIG. 4. Since the formatting into blocks is performed prior to feeding the information into the module 10 and cipher system 20, this function is preferably performed in combiner 22.

As shown in FIG. 4, the block comprises a number of plaintext portions 120 interleaved with random noise 110. Specifically, the plaintext (DATA), preferably previously compressed, is divided into portions 120 containing a maximum of 8192 bytes. If less than 8192 bytes of information are present, a smaller plaintext portion 120 is formed. The same is true if less than 8192 bytes remain after the total (compressed) plaintext is divided into portions. However, as the encryption and decryption arrangement of FIG. 3 processes information in 32-bit words, all plaintext portions 120 must be divisible by 4 bytes. This is achieved by adding a sequence of 0 to 3 bytes of random noise to any short plaintext portion 120.

A header 110 comprising 256 bytes of random noise (N) is inserted at the front of each section. The relative sizes of the data 120 and noise 110 portions have been selected to ensure that the message to be encrypted contains at least about 3% of random noise. It will be apparent to those skilled in the art that this proportion may be changed for certain applications depending on the level of security that is desired.

Further information, denoted by x, may be provided at the end of the block. This preferably includes a checksum for the block and may also comprise further random noise.

In the present embodiment, the number n of plaintext sections 120 per block is limited to 64. Accordingly a block can contain any value between a maximum of 512 Kbytes (i.e. 524,288 bytes) and a minimum of 1 byte of plaintext.

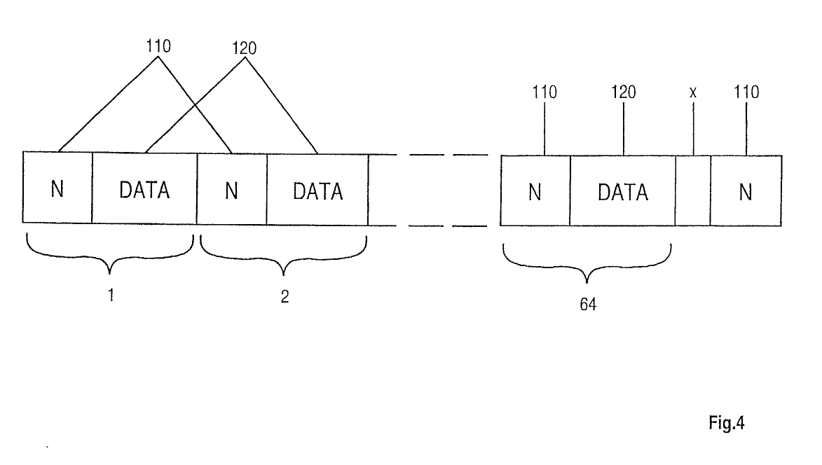

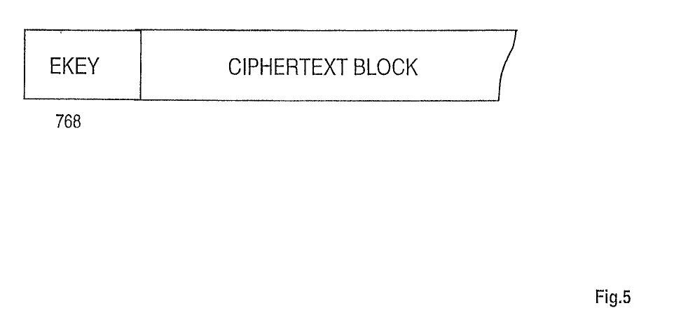

In the present embodiment, the external key EKEY comprises a data sequence that is a multiple of 768 bytes. The number of multiples of 768 bytes determines the number of iterations performed during encryption and decryption as will be described below. During each iteration, a new sequence of 768 bytes from the external key is fed into the apparatus as a header to the input data. The information format fed into the encryption apparatus (module 10 in FIG. 1) is shown in FIG. 5.

An initialization vector (IV) comprising 772 bytes of random noise is also fed into the apparatus and is used during set-up for initializing the state of the module 10. It should be noted that whilst the external key EKEY may be the same for several different messages, the initialization vector IV will be different.

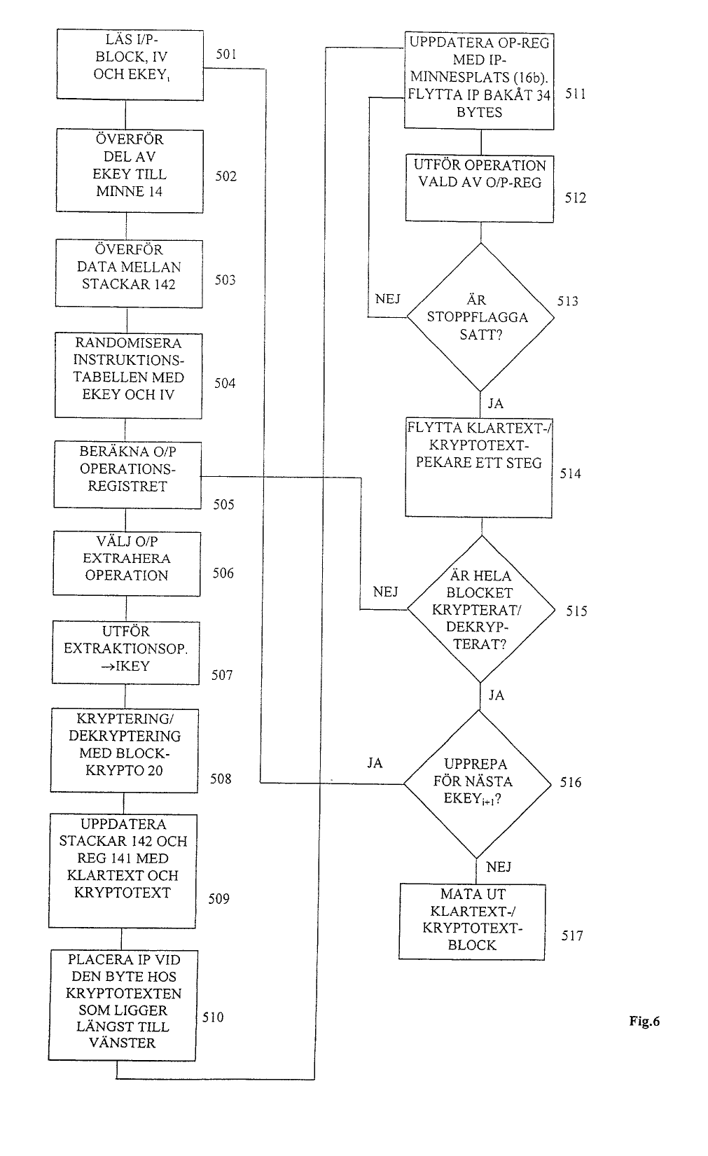

An embodiment of the inventive encryption function is described with reference to FIG. 6. In this procedure and all following procedures it is assumed that the memory of module 10 has the structure and functions depicted in FIG. 2.

The input block of the form shown in FIG. 4 is typically held in a file prior to processing. This block is presented to the cipher system 20 and the module 10 with the external key EKEY in step 501. The first time the process is executed, the memory 14 of the module 10 must be filled with certain initial values. This is performed in steps 502 to 504. Firstly, part of the external key EKEY is transferred to the stacks 142 (step 502). A number of transfer operations between the stacks to further complicate the procedure may be carried out in step 503. Finally the addresses of the instruction table 13 are at least partially randomized using the external key EKEY and the initialization vector IV which has been previously fed into the apparatus in step 501.

The generation of the first internal key IKEY begins in step 505 when the value of an output operation register referred to as op-reg in FIG. 6 is computed. This register actually refers to a particular memory location in the general purpose memory 14. The computation of its value may take the form of adding some information to the previous value of the location. The newly computed value is used to access or address one of a pre-defined number of output operations (step 506). The output operations variously select the values of specific memory locations in the general purpose memory 14, perform some operation on these values and update the result in the output register 15 as the internal key IKEY. In step 507 the selected output operation is executed and the internal key IKEY generated. Encryption of the firsts 32 bits of plaintext is then performed by the block cipher 20 using the internal key IKEY, and the first 32 bits of ciphertext is generated. It should be noted that this first 32-bit unit of ciphertext is generated using only information contained in the external key EKEY and the initialization vector IV; this allows an identical key to be generated for decryption when the block cipher function 20 is reversed. In step 509 the top of the stacks are updated using the 32 bits of ciphertext and the first 32 bits of plaintext, which in this case is the input data constituted by the compressed plaintext and random noise headers. Since the input data comprises 256 bytes of random noise before the compressed message plaintext, the first sixty-four blocks of 32 bits of input data will be comprised entirely of random noise.

In this process, the ciphertext generated by the cipher system 20 is used as program data. Prior to its input into the program memory 12, a header consisting of the 768-byte external key EKEY sequence is added to the ciphertext block and inserted as program into the memory 12. The program data used by the module thus has the general format shown in FIG. 5. In step 510 the instruction pointer IP is moved to the leftmost byte of the ciphertext, and in step 511 the output operation register op-reg is updated with the 16 bits from the memory location pointed to by the instruction pointer IP. The instruction pointer IP is then moved 34 bytes back towards the beginning, i.e. backwards in time, of the input block. In step 512, the value of the output operation register op-reg is then used to select one of the 1024 operations from the instruction table 13. The op-reg actually contains 32 bits, but only 10 bits are used to call an operation. The stop flag is then checked in step 513 and if it is not set, the process returns to step 511 to update the output operation register and move the instruction pointer back a further 34 bytes towards the beginning of the input block. The next operation of the instruction table 13 to be executed will then be selected based upon the contents of the operations register. This process continues until the stop flag is set. A mechanism is also provided to prevent the IP to access a location outside the input string. In one embodiment this is realized by setting the stop flag also on this condition thereby breaking the loop.

As mentioned above with reference to the module 10, a pre-defined number of operations in the instruction table 13 are adapted to update the stop flag. Once the stop flag is set, the pointers to the plaintext and ciphertext are moved one step, that is, into the next 32 bits of plaintext and ciphertext (step 514). This step corresponds to the next 32-bits of plaintext and ciphertext being loaded into the general purpose memory 14 and program memory 12, respectively. If the entire plaintext input block has not been encrypted (step 515), the process returns to step 505 to generate the next internal key IKEY for encrypting the next 32-bit ciphertext sequence. Otherwise, the process continues to step 516 for checking whether there is a new 768-byte key sequence EKEYᵢ₊₁. If so, the process continues at step 501 with the next EKEYᵢ₊₁, and otherwise, the process continues to step 517 to output the plaintext/ciphertext block.

As mentioned above, the block cipher 20 may comprise any conventional cipher primitive that uses substitution tables and various operations at least partially defined by the two keys EKEY and IKEY. Unlike the function of the module 10, which can only be performed in one direction, the block cipher function is reversible, provided the appropriate reverse mapping tables are used and the identical key provided. Accordingly, the decryption of ciphertext using the arrangement of FIG. 3 can also be performed using the procedure illustrated in FIG. 6.

It should be noted that the list of secret external keys EKEY₁, EKEY₂, etc., will be known to persons authorized to decrypt the information.

The initialization vector IV is likewise known, and may even be published. Since the actual operations performed on the memory contents are dependent on the input sequence, and this input sequence by definition will contain some unknown element, a cryptanalyst will have no way of deducing the encryption function from the initialization vector only.

In fact decipherment of an encrypted message requires that the IV vector be known prior to decipherment. The IV is normally sent “in clear” together with the cryptogram. It should be noted that, as the IV as well as the EKEY enters the invention both as program specification and also as input data, to the module 10, that all forthcoming operations and data, internal to the memory 14 as well as present in the output 17, will depend on these inputs.

If the IV is selected truly randomly prior to encrypting the plaintext, no two encrypted messages will share the same IV. If each iteration, according to FIG. 6, is executed with an independent external key EKEYᵢ it is clear that the combination of an EKEYᵢ and an IV will occur only once. The IV is the same for all iterations where the EKEYs will be different and the IV will change to next message where the EKEYs will be the same.

Both the external key EKEY and the initialization vector IV are identical for encryption and decryption. Hence the execution of steps 501 to 507 for each iteration with a new 768-bit EKEY sequence will give the same result. For decryption it should be assumed that the block decryption performed in step 508 will be the inverse of the encryption function and will result in the generation of 32 bits of plaintext from the first 32 bits of ciphertext. The remaining steps 510 to 513 are executed as for encryption. It should be noted that the order of the external keys EKEY used will be reversed for decryption.

A schematic of the encryption and decryption for a single iteration using a cipher function and a key IKEY generated by the module 10 is given in FIG. 7. Here it is apparent that a first internal key IKEY₀ used to generate the first 32-bit unit of ciphertext from the first 32-bit unit of plaintext is a function of the external key EKEY and the initialization vector IV. The module 10 uses this first unit of ciphertext and the first unit of plaintext in addition to the external key EKEY and the initialization vector IV to generate the second key IKEY₁ which is used in the cipher system 20 to generate a second unit of ciphertext from the second unit of plaintext. This process continues until all the plaintext has been processed. The final key IKEYₙ₊₁ used to encrypt or decrypt the final units of plaintext and ciphertext will be a function of all the previous (0 to n) units of plaintext and ciphertext It is apparent from the schematic of FIG. 7 that the complexity of encryption increases for each unit, because the information content of the internal key IKEY becomes a function of all previously input plaintext and generated ciphertext. However, while the encryption of the first unit may be relatively weak owing to the relative simplicity of the key IKEY, this can be mitigated by iterating the encryption of the whole message using several different keys EKEY.

Furthermore, by reversing the order of the units for each iteration, the nominal strength of encryption of each unit will be equivalent, as each unit of ciphertext will be generated using keys IKEY that in total comprise information from the whole plaintext/ciphertext block. This implies that in FIG. 6, box 514, the pointers of ciphertext/plaintext blocks could move in either direction. In 511 the move of the IP pointer will always be backwards.

Once the full input information has been recovered, the correct decryption can be checked using the checksum tagged on the end of the input block. The 256 bytes of random noise header is then separated from the message information and the message information decompressed if it had been initially compressed.

Since the pointer to the plaintext/ciphertext block is incremented or decremented in the plaintext or ciphertext in units of 32 bits, the first 64 operations on plaintext will actually be performed on the random noise N header (see FIG. 4). This ensures that the initial contents of the general purpose memory 14 comprising the stacks 142 and registers 141 will be filled with random information before the first 32-bit word of plaintext/ciphertext is loaded into program memory 12.

Due to the observed structure of most input strings the present embodiment of the invention actually process the input plaintext block (FIG. 4) in the right-to-left direction during the first iteration of the process according to FIG. 6., as this would be a security advantage for these inputs, and be of no significance to all other possible input strings.

Whilst random noise is simply placed at the head of each data sequence as shown in FIG. 4, in a further embodiment of the invention this random noise is utilized to randomize the plaintext using a system based on iterating the states of cellular automata.

In a further embodiment of the invention, the block cipher 20 incorporates substitution tables which are initialized using the initialization vector IV and external key EKEY. In a still further embodiment of the invention the above mentioned substitution tables are continuously updated to make the mapping from the input to the output varying. This is accomplished by swapping the addressed line of the decryption (incl. encryption) substitution table with another line addressed by a special field of the IKEY data. Since the mapping defined by a substitution table used in encryption must be inverted for decryption, any amendment of this mapping at set-up must be followed by the inversion of the table. In the preferred embodiment, a substitution table for decryption is generated during set-up, and then has to be inverted to obtain the substitution table for encryption. Upon decryption of the ciphertext, only the decryption substitution table need be created. This means that processing cost is reduced in decryption compared to encryption.

It is preferred that in addition to at least one substitution table, the block cipher 20 includes a plurality of parallel operations, wherein the operations executed for any particular block is determined by the internal key IKEY generated by the module 10. This may be viewed as an arrangement of parallel paths, each path being associated with a specific operation. The internal key IKEY acts as a router, sending the plaintext or partially encrypted block down one of the paths. The operations may include, but are not limited to, mapping functions, the rotation of the block and addition operations. One path may include no operation at all. This allows the function to be performed rapidly without compromising security, since the probability that a block undergoes a specific operation depends on the number of possible paths.

It will be understood that the dimensions used for the various elements of data, for example the external key EKEY, the initialization vector IV, and the units in which the plaintext and ciphertext are manipulated in the module 10 and the cipher system 20 are given by way of example only. It will be apparent to those skilled in the art that these values may be modified to increase the security of the cipher function or reduce the processing time for any specific operation. Furthermore, modifications may be made to the content of the module 10 for the same purpose.

As for the size of the external (secret) input key EKEY note that, at least in the present exemplifying embodiment of the invention, the key could be viewed as a compressed input software module, possibly written in the module-13-language. Its recommended size should therefore preferably be in the order of several hundred bytes. This argument applies to the other inputs as well, such as the size of the input plaintext block and the size of the random Initialization Vector IV. Note that this is implicitly included in the preferred structure of the input (FIG. 4). This will be an issue mostly when using the invention in security related environments, and it should be noted that in random number applications (by example only) of the present invention, this note may be of no relevance.

Also implicitly included in the present embodiment of the invention is that the internal information paths are intentionally of different sizes in different places. Referring to FIG. 3 the flow of information IKEY from module 10 to module 20 is much higher than the flow of information through module 20. Each 32 bits of plaintext, to be encrypted by module 20, corresponds to one instance of IKEY, which, in the preferred embodiment, has the size 8 times 32 bits (or 13 times 32 bits from module 14 to module 15 in FIG. 1).

This implies that each 32 bits of output from module 20 could, depending on IKEY, correspond to any 32 bit input plaintext, and that for each 32 bit output, from module 20, or possible each combination of 32 bit input and 32 bit output from module 20, could correspond to a large subset of all possible internal keys IKEY.

The man skilled in the field of the present invention will clearly see the benefit of this construction, but note that in other application areas of the present invention, such as random number generation, this may not be necessary to achieve.

An important characteristic of the arrangement and method according to the present invention is that providing an increased number of operations in the instruction table 13 will substantially improve the security of a system, or the quality of generated random numbers, by increasing the possible operations that may be performed. However, although such a modification will involve a higher initial hardware or software outlay, the delay in encryption or decryption will not be increased, if it is assumed that all instructions can be executed in approximately the same length of time. Accordingly, the security of a system may be increasing without an associated time penalty.

The inventive method may be realised by means of hardware as well as software programs executed on a computer comprising a processor, storage means and input/output means. A selected realisation comprises functional means arranged to perform the different steps of the function of the invention as has been described in the present description. An embodiment of the invention in the shape of a computer program can further be realised as a computer program product possibly comprising a storage medium and means, stored on the storage medium, for controlling a computer to perform the functions and the steps of the invention. Another embodiment of the invention is realised as a data stream or a carrier signal modulated by signals representing a computer program arranged to control a data processing apparatus, for example a computer, to perform the functions and the steps of the invention.

The present invention has been shown and described in terms of specific embodiments, but it is obvious for the person skilled in the art that different combinations and modification of features can be made without departing from the scope of the invention as described in the appending claims.

Appendix A

Appendix A contains descriptions of embodiments of the invention expressed in language similar to patent claims. THESE ARE NOT CLAIMS

1. An information processing arrangement for converting message information from a first format into a second format, comprising:

a memory (14) for storing data,

means (16, 11, 12) for updating said memory with input information,

an instruction table (13) comprising a set of operations adapted to modify the state of said memory (14),

processing means (11) adapted to select operations from said instruction table (13) in response to at least part of said input information, and to execute said selected operations on the contents of said memory (14), at least one of said set of operations being selectable in response to any possible configuration of at least part of said input information, and

means (15) for extracting output information from said memory (14).

2. An arrangement as in Paragraph 1, wherein said processing means (11) are adapted to respond to predetermined sized portions of said input information, said instruction table (13) comprising a number of operations that is at least equal to the total number of permutations of one of said portions.

3. An arrangement as in Paragraphs 1 or 2, wherein said memory (14) is extensible.

4. An arrangement as in Paragraphs 1 to 3, wherein said memory is a random access memory.

5. An arrangement as in Paragraphs 1 to 4, wherein said extraction means (11, 15) are adapted to extract output data in response the value of a stop flag, wherein at least one operation in said instruction table (13) is configured to update the value of said stop flag.

6. An arrangement as in Paragraphs 1 to 5, wherein said memory (14) is configured to comprise at least one stack (142).

7. An arrangement as in Paragraphs 1 to 6, wherein said memory (14) comprises at least one register (141).

8. An arrangement as in Paragraphs 1 to 7, wherein the operations in said instruction table (13) are devised to cause said processing means (11) to update portions of said memory containing input information or a result of operations on said input information only.

9. An arrangement as in Paragraphs 1 to 8, wherein the operations in said instruction table (13) are different from one another and/or wherein the operations in said instruction table (13) comprise such a large number of different operations that all combinations of said instructions can be simulated only by a data processing device having full computability.

10. A system for the encryption and decryption of message data comprising a data processing arrangement (10) as in Paragraphs 1 to 9, and a cipher device (20), said cipher device being adapted to receive message data and at least one cipher key (IKEY) and generate encrypted data corresponding to an encryption of said message data, wherein an output of said data processing arrangement (10) is connected to said cipher device (20) to output data extracted from said data processing arrangement (10) as said cipher key (IKEY).

11. A system as in Paragraph 10, including noise generating means for incorporating random noise with said message data.

12. A system as in Paragraphs 10 or 11, including data compression means for compressing said message data.

13. A system as in Paragraphs 10 to 12, comprising means (11, 12) for inputting said message data as input information into said data processing arrangement (10), and means for updating said memory (14) on the basis of said message data.

14. A system as in Paragraph 13, wherein said processing means (11) are adapted to select operations from said instruction table (13) in response to at least part of said message data.

15. A system as in Paragraphs 10 to 14, comprising means (11, 12) for inputting said encrypted data into said data processing arrangement (10), and means for updating said memory (14) on the basis of said encrypted data.

16. A system as in Paragraph 15, wherein said processing means (11) are adapted to select operations from said instruction table (13) in response to at least part of said encrypted data.

17. A system as in Paragraphs 10 to 16, wherein said cipher device (20) is adapted to perform a block cipher function.

18. A system as in Paragraphs 10 to 16, wherein said cipher device (20) is adapted to perform a stream cipher function.

19. A system as in Paragraphs 10 to 18, including means (11, 12, 14) for inputting a second cipher key (EKEY), and means (11) for updating said memory (14) on the basis of said second cipher key (EKEY).

20. A system as in Paragraph 19, including means for combining said second cipher key with said input information.

21. A system as in Paragraph 20, including means for configuring said cipher device on the basis of said second cipher key (EKEY).

22. A system as in Paragraphs 10 to 21, including means (11, 14) for inputting a random noise sequence (IV), and means (11) for updating said memory (14) on the basis of said random noise sequence.

23. A method for the conversion of information from a first format into a second format comprising:

establishing a set of operations for modifying the state of a memory,

storing input information in a first format in said memory,

selecting operations from said set in response to at least part of said input information and executing said operations on information stored in said memory, wherein said set of operations is devised such that an operation can be selected in response to any possible input information stream, and

extracting information from said memory in a second format after executing at least one operation.

24. A method as in Paragraph 23 including selecting operations on the basis of a portion of said input information, said portion having a number of possible values that is no greater than the number of established operations.

25. A method as in Paragraphs 23 or 24 including defining a value of an entity to indicate when information can be extracted, at least one of said operations being adapted to update the value of said entity on execution.

26. A method as in Paragraphs 23 to 25, wherein said operations include substitution, addition, subtraction and rotation operations, and/or an operation devised to alter the order of the other operations.

27. A method as in Paragraphs 23 to 26, wherein said operations are each different from one another and/or wherein the operations in said instruction table (11) comprise such a large number of different operations that all combinations of said instructions can be simulated only by a data processing device having full computability.

28. A method for the encryption and decryption of message data comprising the method as in Paragraphs 23 to 27, including utilizing said information extracted from said memory as a cipher key and encrypting said message data with a cipher function and said cipher key to generate encrypted information.

29. A method as in Paragraph 28, including utilizing said message data as at least part of said input information.

30. A method as in Paragraphs 28 or 29, including incorporating random noise with said message data prior to encryption.

31. A method as in Paragraphs 28 to 30, including compressing said message data prior to encryption.

32. A method as in Paragraphs 28 to 31, including utilizing said encrypted information as at least part of said input information.

33. A method as in Paragraphs 28 to 32, including utilizing a second cipher key (EKEY) to modify the contents of at least one of said instruction set and said memory.

34. A method as in Paragraphs 28 to 33, including utilizing a second cipher key (EKEY) as input information.

35. A method as in Paragraph 34, including iterating the encryption of message data a predetermined number of times.

36. A method as in Paragraph 35, wherein a different second cipher key (EKEY) is utilized for each iteration.

37. A method as in Paragraphs 35 or 36, wherein the number of iterations is determined by said second cipher key (EKEY).

38. A method as in Paragraphs 28 to 37 including utilizing a random noise sequence (IV) to modify the contents of at least one of said instruction set and/or said memory.

39. A method as in Paragraphs 28 to 38, wherein said cipher function is a block cipher function.

40. A method as in Paragraph 39, including utilizing said second cipher key (EKEY) to initialize said block function.

41. A method as in Paragraphs 28 to 38, wherein said cipher function is a stream cipher function.

42. An arrangement for the encryption and decryption of information comprising:

a cipher system (20),

message data inputting means (21, 22) communicating with said cipher system, said cipher system being adapted to output ciphertext in response to said message data and a cipher key,

wherein means (10) for generating said cipher key are adapted to receive said message data, generate a cipher key as a function of said message data and output said cipher key to said cipher system.

43. An arrangement as in Paragraph 42, wherein said cipher generating means communicates with the output of said cipher system to receive said ciphertext and is adapted to generate said cipher key as a function of said ciphertext.

44. An arrangement as in Paragraphs 42 or 43, wherein said message data inputting means comprise random noise generating means connected to the input of said cipher system for combining noise data with said message data.

45. An arrangement as in Paragraphs 42 to 44, characterized in that said cipher system is adapted to receive a second cipher key and to generate said ciphertext as a function of said second cipher key.

46. An arrangement as in Paragraph 45, wherein said key generating means is adapted to receive said second cipher key and to generate said cipher key as a function of said second cipher key.

47. An arrangement as in Paragraphs 42 to 46, wherein data compression means are associated with said message data input means for compressing said message data prior to its combination with said random noise data.

48. An arrangement as in Paragraphs 42 to 47, characterized in that said key generating means comprise memory means, means for inputting said message data into said memory means, an instruction lookup table containing a set of predetermined operations, processing means adapted to select operations from said lookup table in response to the content of said memory means and to execute said operations on the content of said memory means in accordance with said instructions, wherein said processing means are adapted to select a valid operation for all possible data contained in said memory means, and means for extracting data from said memory means, and/or possibly wherein the operations in said instruction table (11) comprise such a large number of different operations that all combinations of said instructions can be simulated only by a data processing device having full computability.

49. A machine readable electronic data recording device for use in a digital data processing machine, said data recording means being encoded with data representing a method for encrypting and decrypting information as in Paragraphs 23 to 41.

50. A carrier signal modulated by signals representing a computer program adapted to control a digital data processing machine to perform a method as in Paragraphs 23 to 41.

[End of Appendix A.]

What is claimed:

1. An information processing apparatus for converting message information from a first format into a second format, comprising:
a first cipher unit having a first cipher key input and a data output for outputting a data stream generated dependent on a first cipher key input via said first cipher key input,
a second cipher unit having a plaintext input a second cipher key input and a ciphertext output said second cipher unit via said cipher key input being communicatively coupled to said data output of the first cipher unit for receiving a second cipher key in the shape of said data stream; and
said first cipher unit being arranged to perform, dependent on a predetermined rule, a renewed generation of a data stream for use as said second cipher key.

2. An information processing apparatus as recited in claim 1, further being arranged to perform said renewed generation of a data stream for each occasion of key output.

3. An information processing apparatus as recited in claim 1, further comprising a synchronizing mechanism between the first and the second cipher unit being devised such that a renewed generation of a data stream is performed dependent on a synchronizing signal from the second cipher unit.

4. An information processing apparatus as recited in claim 1, further comprising a buffer for said data stream said buffer being arranged to output a data stream stored in the buffer dependent on a synchronizing signal from the second cipher unit.

5. An information processing apparatus as recited in claim 1, farther comprising a format adaptation mechanism devised to adapt said data stream to a format for a cipher key which is acceptable to said second cipher unit.

6. An information processing apparatus as recited in claim 1, wherein said second cipher unit is arranged to generate a block cipher.

7. An information processing apparatus as recited in claim 1, further being arranged to adapt said data stream to a format adapted to a cipher system that is arranged to generate a block cipher.

8. An information processing apparatus as recited in claim 1, wherein said second cipher unit is arranged to generate a stream cipher.

9. An information processing apparatus as recited in claim 1, further being arranged to adapt said data stream to a format adapted to a cipher system being arranged to generate a stream cipher.

10. An information processing apparatus as recited in claim 1, wherein said second cipher unit is arranged to generate encryption in accordance with DES.

11. An information processing apparatus as recited in claim 1, further being arranged to adapt said data stream to a format adapted to a cipher system being arranged to perform encryption in accordance with DES.

12. An information processing apparatus as recited in claim 1, wherein said second cipher unit is arranged to perform encryption in accordance with AES.

13. An information processing apparatus as recited in claim 1, further being arranged to adapt said data stream to a format adapted to a cipher system being arranged to perform encryption in accordance with AES.

14. An information processing apparatus as recited in claim 1, wherein said second cipher unit is arranged to perform encryption in accordance with the requirements in GSM, for example A5/1 or A5/2.

15. An information processing apparatus as recited in claim 1, further being arranged to adapt said data stream to a format adapted to a cipher system arranged to perform encryption in accordance with the requirements in GSM, for example A5/1 or A5/2.

16. An information processing apparatus for converting message information from a first format into a second format, comprising:
a first cipher unit having a first cipher key input and a data output for outputting a data stream generated dependent on a first cipher key input via said first cipher key input said first cipher unit comprising a memory for storage of data, means for updating said memory with input information, an instruction table having a set of operations arranged to modify the state of said memory, processing means arranged to select operations from said instruction table dependent on at least parts of said input information, and to execute said selected operations on the content of said memory wherein at least one of said set of operations is selectable dependent on every possible configuration of at least parts of said input information, and means for extracting output information from said memory,
a second cipher unit having a plaintext input a second cipher key input and a ciphertext out said second cipher unit via said second cipher key input being communicatively coupled to said data output of the first cipher unit for receiving a second cipher key in the shape of said data stream; and
said first cipher unit being arranged to perform, dependent on a predetermined rule, a renewed generation of a data stream for use as said second cipher key.

17. An information processing apparatus as recited in claim 16, further being arranged to perform said renewed generation of a data stream for each occasion of key output.

18. An information processing apparatus as recited in claim 16, further comprising a synchronizing mechanism between the first and the second cipher unit being devised such that a renewed generation of a data stream is performed dependent on a synchronizing signal from the second cipher unit.

19. An information processing apparatus as recited in claim 16, further comprising a buffer for said data stream said buffer being arranged to output a data stream stored in the buffer dependent on a synchronizing signal from the second cipher unit.

20. An information processing apparatus as recited in claim 16, further comprising a format adaptation mechanism devised to adapt said data stream to a format for a cipher key which is acceptable to said second cipher unit.

21. An information processing apparatus as recited in claim 16, wherein said second cipher unit is arranged to generate a block cipher.

22. An information processing apparatus as recited in claim 16, further being arranged to adapt said data stream to a format adapted to a cipher system that is arranged to generate a block cipher.

23. An information processing apparatus as recited in claim 16, wherein said second cipher unit is arranged to generate a stream cipher.

24. An information processing apparatus as recited in claim 16, further being arranged to adapt said data stream to a format adapted to a cipher system being arranged to generate a stream cipher.

25. An information processing apparatus as recited in claim 16, wherein said second cipher unit is arranged to generate encryption in accordance with DES.

26. An information processing apparatus as recited in claim 16, further being arranged to adapt said data stream to a format adapted to a cipher system being arranged to perform encryption in accordance with DES.

27. An information processing apparatus as recited in claim 16, wherein said second cipher unit is arranged to perform encryption in accordance with AES.

28. An information processing apparatus as recited in claim 16, further being arranged to adapt said data stream to a format adapted to a cipher system being arranged to perform encryption in accordance with AES.

29. An information processing apparatus as recited in claim 16, wherein said second cipher unit is arranged to perform encryption in accordance with the requirements in GSM, for example A5/1 or A5/2.

30. An information processing apparatus as recited in claim 16, further being arranged to adapt said data stream to a format adapted to a cipher system arranged to perform encryption in accordance with the requirements in GSM, for example A5/1 or A5/2.

31. An information processing apparatus as recited in claim 16, further comprising a feedback unit coupled to said memory and arranged to combine a first processing material with a processing material obtained from a previous processing step, to feedback processing material to a program memory and to output a data stream in the shape of a completed internal key.

32. An information processing apparatus as recited in claim 31, wherein the feedback unit comprises a feedback memory, possibly realized as a stack, coupled to a functional unit having a feedback to the feedback memory and to the output of the feedback unit according to a predetermined function.

33. An information processing apparatus as recited in claim 32, wherein the functional unit comprises a linear feedback and/or a non-linear feedback.

34. An information processing apparatus as recited in claim 32, wherein the functional unit comprises a select operator a plurality of operators coupled to memory outputs and an addition operator coupled to the operators, wherein the select operator is arranged to select an operator dependent on a predetermined rule.

35. An information processing apparatus as recited in claim 16, wherein the memory comprises two memory units a cross connection unit and a second memory means having a control unit and a memory space arranged for storing status information of the memory units where any of the two firstly mentioned memory units is externally available and wherein it is arranged such that the content in said second memory means is exchangeable.

36. An information processing apparatus as recited in claim 35, wherein the cross connection unit is arranged such that both memory parts can be called simultaneously, and such that the memory parts are instantaneously interchangeable.

37. A computer implemented information processing method for converting message information from a first format into a second format, comprising the steps of:
a first encryption algorithm taking a first cipher key as an input and generating a data stream dependent on said first cipher key;
a second encryption algorithm taking plaintext as an input, taking a second cipher key as an input and generating a ciphertext dependent on said plaintext and on said second cipher key said second encryption algorithm receiving a second cipher key in the shape of said data stream from said first encryption algorithm; and
said first encryption algorithm performing, dependent on a predetermined rule, a renewed generation of a data stream for use as said second cipher key

38. An information processing method as recited in claim 37, further comprising the step of performing said renewed generation of a data stream for each occasion of key output.

39. An information processing method as recited in claim 37, further comprising the step of synchronizing the steps in the first and the second encryption algorithms such that the renewed generation of a data stream is performed dependent on a synchronizing parameter from the second encryption algorithm.

40. An information processing method as recited in claim 37, further comprising the steps of buffering said data stream and forwarding a stored data stream dependent on a synchronizing parameter from the second encryption algorithm.

41. An information processing method as recited in claim 37, further comprising the step of adapting said data stream to a format for a cipher key which is acceptable to said second encryption algorithm.

42. An information processing method as recited in claim 37, wherein said second encryption algorithm is arranged to generate a block cipher.

43. An information processing method as recited in claim 37, further comprising the step of adapting said data stream to a format adapted to an encryption algorithm that is arranged to generate a block cipher.

44. An information processing method as recited in claim 37, wherein said second encryption algorithm is arranged to generate a stream cipher.

45. An information processing method as recited in claim 37, further comprising the step of adapting said data stream to a format adapted to an encryption algorithm being arranged to generate a stream cipher.

46. An information processing method as recited in claim 37, wherein said second encryption algorithm is arranged to generate encryption in accordance with DES.

47. An information processing method as recited in claim 37, further comprising the step of adapting said data stream to a format adapted to an encryption algorithm being arranged to perform encryption in accordance with DES.

48. An information processing method as recited in claim 37, wherein said second encryption algorithm is arranged to perform encryption in accordance with AES.

49. An information processing method as recited in claim 37, further comprising the step of adapting said data stream to a format adapted to an encryption algorithm being arranged to perform encryption in accordance with AES.

50. An information processing method as recited in claim 37, wherein said second encryption algorithm is arranged to perform encryption in accordance with the requirements in GSM, for example A5/1 or A5/2.

51. An information processing method as recited in claim 37, further comprising the step of adapting said data stream to a format adapted to an encryption algorithm arranged to perform encryption in accordance with the requirements in GSM, for example A5/1 or A5/2.

52. A computer implemented information processing method for converting message information from a first format into a second format, comprising the steps of:
a first encryption algorithm including the steps of establishing a set of operations arranged for modifying the state of a memory, storing input information in a first format in said memory, selecting operations from said set of operations dependent on at least parts of said input information, and executing said selected operations on the content of said memory, wherein at least one of said set of operations is selectable dependent on every possible configuration of said input information, and extracting information from said memory in a second format after the execution of at least one operation;
a second encryption algorithm taking plaintext as an input, taking a second cipher key as an input and generating a ciphertext dependent on said plaintext and on said second cipher key said second encryption algorithm receiving a second cipher key in the shape of said data stream from said first encryption algorithm; and
said first encryption algorithm performing, dependent on a predetermined rule, a renewed generation of a data stream for use as said second cipher key.

53. An information processing method as recited in claim 52, further comprising the step of performing said renewed generation of a data stream for each occasion of key output.

54. An information processing method as recited in claim 52, further comprising the step of synchronizing the steps in the first and the second encryption algorithms such that the renewed generation of a data stream is performed dependent on a synchronizing parameter from the second encryption algorithm.

55. An information processing method as recited in claim 52, further comprising the steps of buffering said data stream and forwarding a stored data stream dependent on a synchronizing parameter from the second encryption algorithm.

56. An information processing method as recited in claim 52, further comprising the step of adapting said data stream to a format for a cipher key which is acceptable to said second encryption algorithm.

57. An information processing method as recited in claim 52, wherein said second encryption algorithm is arranged to generate a block cipher.

58. An information processing method as recited in claim 52, further comprising the step of adapting said data stream to a format adapted to an encryption algorithm that is arranged to generate a block cipher.

59. An information processing method as recited in claim 52, wherein said second encryption algorithm is arranged to generate a stream cipher.

60. An information processing method as recited in claim 52, further comprising the step of adapting said data stream to a format adapted to an encryption algorithm being arranged to generate a stream cipher.

61. An information processing method as recited in claim 52, wherein said second encryption algorithm is arranged to generate encryption in accordance with DES.

62. An information processing method as recited in claim 52, further comprising the step of adapting said data stream to a format adapted to an encryption algorithm being arranged to perform encryption in accordance with DES.

63. An information processing method as recited in claim 52, wherein said second encryption algorithm is arranged to perform encryption in accordance with AES.

64. An information processing method as recited in claim 52, further comprising the step of adapting said data stream to a format adapted to an encryption algorithm being arranged to perform encryption in accordance with AES.

66. An information processing method as recited in claim 52, wherein said second encryption algorithm is arranged to perform encryption in accordance with the requirements in GSM, for example A5/1 or A5/2.

67. An information processing method as recited in claim 52, further comprising the step of adapting said data stream to a format adapted to an encryption algorithm arranged to perform encryption in accordance with the requirements in GSM, for example A5/1 or A5/2.

68. An information processing method as recited in claim 52, further comprising the steps of combining, in a feedback stage, a first processing material with a processing material obtained from a previous processing step, feeding back processing material to a program memory and outputting a data stream in the shape of a completed internal key.

69. An information processing method as recited in claim 67, wherein the feedback stage comprises a linear feedback and/or a non-linear feedback.

70. An information processing method as recited in claim 67, further comprising the step of selecting a function operator from a plurality of operators dependent on a predetermined rule.

71. An information processing method as recited in claim 67, further comprising the steps of initializing said memory in the shape of two memory units, cross connecting said memory units to the memory output and to a second memory means, storing status information of the memory units in another memory space, wherein any of the two firstly mentioned memory units is externally available and wherein it is arranged such that the content in said second memory means is exchangeable.

72. An information processing method as recited in claim 70, wherein the cross connection is arranged such that both memory parts can be called simultaneously, and such that the memory parts are instantaneously interchangeable.

73. A computer program product, for use in a data processing system, for converting message information from a first format into a second format, comprising program code for directing the data processing system:
to perform a first encryption algorithm taking a first cipher key as an input and generating a data stream dependent on said first cipher key;
to perform a second encryption algorithm taking plaintext as an input, taking a second cipher key as an input and generating a ciphertext dependent on said plaintext and on said second cipher key said second encryption algorithm receiving a second cipher key in the shape of said data stream from said first encryption algorithm; and
to perform by means of said first encryption algorithm and, dependent on a predetermined rule, a renewed generation of a data stream for use as said second cipher key.

74. A computer program product as recited in claim 72, further comprising program code for directing the data processing system to perform said renewed generation of a data stream for each occasion of key output.

75. A computer program product as recited in claim 72, further comprising program code for directing the data processing system to synchronize the steps in the first and the second encryption algorithms such that the renewed generation of a data stream is performed dependent on a synchronizing parameter from the second encryption algorithm.

76. A computer program product as recited in claim 72, further comprising program code for directing the data processing system to buffer said data stream and to forward a stored data stream dependent on a synchronizing parameter from the second encryption algorithm.

77. A computer program product as recited in claim 72, further comprising program code for directing the data processing system to adapt said data stream to a format for a cipher key which is acceptable to said second encryption algorithm.

78. A computer program product as recited in claim 72, wherein said second encryption algorithm is arranged to generate a block cipher.

79. A computer program product as recited in claim 72, further comprising program code for directing the data processing system to adapt said data stream to a format adapted to an encryption algorithm that is arranged to generate a block cipher.

80. A computer program product as recited in claim 72, wherein said second encryption algorithm is arranged to generate a stream cipher.

81. A computer program product as recited in claim 72, further comprising program code for directing the data processing system to adapt said data stream to a format adapted to an encryption algorithm being arranged to generate a stream cipher.

82. A computer program product as recited in claim 72, wherein said second encryption algorithm is arranged to generate encryption in accordance with DES.

83. A computer program product as recited in claim 72, further comprising program code for directing the data processing system to adapt said data stream to a format adapted to an encryption algorithm being arranged to perform encryption in accordance with DES.

84. A computer program product as recited in claim 72, wherein said second encryption algorithm is arranged to perform encryption in accordance with AES.

85. A computer program product as recited in claim 72, further comprising program code for directing the data processing system to adapt said data stream to a format adapted to an encryption algorithm being arranged to perform encryption in accordance with AES.

86. A computer program product as recited in claim 72, wherein said second encryption algorithm is arranged to perform encryption in accordance with the requirements in GSM, for example A5/1 or A5/2.

87. A computer program product as recited in claim 72, further comprising program code for directing the data processing system to adapt said data stream to a format adapted to an encryption algorithm arranged to perform encryption in accordance with the requirements in GSM, for example A5/1 or A5/2.

88. A computer program product for converting message information from a first format into a second format, comprising program code for directing the data processing system:
to perform a first encryption algorithm including the steps of establishing a set of operations arranged for modifying the state of a memory, storing input information in a first format in said memory, selecting operations from said set of operations dependent on at least parts of said input information, and executing said selected operations on the content of said memory, wherein at least one of said set of operations is selectable dependent on every possible configuration of said input information, and extracting information from said memory in a second format after the execution of at least one operation;
to perform a second encryption algorithm taking plaintext as an input, taking a second cipher key as an input and generating a ciphertext dependent on said plaintext and on said second cipher key said second encryption algorithm receiving a second cipher key in the shape of said data stream from said first encryption algorithm; and
to perform, by means of said first encryption algorithm and dependent on a predetermined rule, a renewed generation of a data stream for use as said second cipher key.

89. A computer program product as recited in claim 87, further comprising program code for directing the data processing system to perform said renewed generation of a data stream for each occasion of key output.

90. A computer program product as recited in claim 87, further comprising program code for directing the data processing system to synchronize the steps in the first and the second encryption algorithms such that the renewed generation of a data stream is performed dependent on a synchronizing parameter from the second encryption algorithm.

91. A computer program product as recited in claim 87, further comprising program code for directing the data processing system to buffer said data stream and to forward a stored data stream dependent on a synchronizing parameter from the second encryption algorithm.

92. A computer program product as recited in claim 87, further comprising program code for directing the data processing system to adapt said data stream to a format for a cipher key which is acceptable to said second encryption algorithm.

93. A computer program product as recited in claim 87, wherein said second encryption algorithm is arranged to generate a block cipher.

94. A computer program product as recited in claim 87, further comprising program code for directing the data processing system to adapt said data stream to a format adapted to an encryption algorithm that is arranged to generate a block cipher.

95. A computer program product as recited in claim 87, wherein said second encryption algorithm is arranged to generate a stream cipher.

96. A computer program product as recited in claim 87, further comprising program code for directing the data processing system to adapt said data stream to a format adapted to an encryption algorithm being arranged to generate a stream cipher.

97. A computer program product as recited in claim 87, wherein said second encryption algorithm is arranged to generate encryption in accordance with DES.

98. A computer program product as recited in claim 87, further comprising program code for directing the data processing system to adapt said data stream to a format adapted to an encryption algorithm being arranged to perform encryption in accordance with DES.

99. A computer program product as recited in claim 87, wherein said second encryption algorithm is arranged to perform encryption in accordance with AES.

100. A computer program product as recited in claim 87, further comprising program code for directing the data processing system to adapt said data stream to a format adapted to an encryption algorithm being arranged to perform encryption in accordance with AES.

101. A computer program product as recited in claim 87, wherein said second encryption algorithm is arranged to perform encryption in accordance with the requirements in GSM, for example A5/1 or A5/2.

102. A computer program product as recited in claim 87, further comprising program code for directing the data processing system to adapt said data stream to a format adapted to an encryption algorithm arranged to perform encryption in accordance with the requirements in GSM, for example A5/1 or A5/2.

103. A computer program product as recited in claim 87, further comprising program code for directing the data processing system to combine, in a feedback stage, a first processing material with a processing material obtained from a previous processing steep, to feed back processing material to a program memory and to output a data stream in the shape of a completed internal key

104. A computer program product as recited in claim 102, wherein the feedback stage comprises a linear feedback and/or a non-linear feedback.

105. A computer program product as recited in claim 102, further comprising program code for directing the data processing system to select, for the feedback, a function operator from a plurality of operators dependent on a predetermined rule.

106. A computer program product as recited in claim 102, further comprising program code for directing the data processing system to initialize said memory in the shape of two memory units, to cross connect said memory units to the memory output and to a second memory means, to store status information of the memory units in another memory space, wherein any of the two firstly mentioned memory units is externally available and wherein it is arranged such that the content in said second memory means is exchangeable.

107. A computer program product as recited n claim 105, wherein the cross connection unit is arranged such that both memory parts can be called simultaneously, and such that the memory parts are instantaneously interchangeable.
